(19) United States
(12) Patent Application Publication
(10) Pub. No.: US 2004/0202955 A1
(43) Pub. Date: Oct. 14, 2004

(54) Method for making printing plate by inkjet deposition of coalescing agent

(76) Inventor: Jonathan W. Goodin, Tyler, TX (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/772,332

(22) Filed: Feb. 6, 2004

Related U.S. Application Data
(60) Provisional application No. 60/447,006, filed on Feb. 13, 2003.

(51) Int. Cl. G03C 5/00

(52) U.S. Cl. 430/269; 430/320

(57) ABSTRACT

An inkjet method is used to make an offset lithographic printing master by imagewise application of droplets of a coalescing agent on a layer of imageable medium comprising hydrophobic polymer particles, pre-coated on a hydrophilic lithographic base. Treatment with a developer removes those areas of the layer that have not been imagewise coalesced, thereby revealing the underlying hydrophilic base to create a lithographic printing master. The combination of imageable media and coalescing agent may be used in the fully on-press fabrication of a negative-working lithographic master, which may optionally also be made on a re-usable base.

### FIELD OF THE INVENTION

The invention pertains to the field of lithographic printing and, in particular, to the making of offset printing plates using inkjet technology to imagewise deposit coalescing agents onto media comprising hydrophobic polymer particles.

### BACKGROUND OF THE INVENTION

In the art of lithographic printing it is generally required that one or more lithographic printing plates be mounted on a printing press. In the case of wet offset lithographic printing, the lithographic printing plate is characterized by having on its printing surface oleophilic ink-receiving areas in the form of the image to be printed, and hydrophilic water-receiving areas corresponding to the other, non-printing areas of the surface. Because of the immiscibility of oil-based lithographic inks and water, on a well-prepared printing plate, ink will fully coat the oleophilic areas of the printing surface of the plate and not adhere to the hydrophilic areas. The operating press brings the inked plate surface into intimate contact with an impression cylinder or elastic transfer blanket that transfers the ink image to the media to be printed.

Lithographic printing plates generally have images that are planographic, i.e., substantially flat. However, other printing plates with similar photosensitive coatings may have raised images for relief printing or intaglio images for gravure printing. Lithographic printing processes may use water as described above, or they may use a waterless printing technique. If a waterless technique is used, then the discrimination between the inked and non-inked areas of the plate surface is based on having different surface energies in the imaged and unimaged areas, leading to differences in oleophilicity. Plates based on a silicone-formulation, being one of a very few practical materials that are inherently oleophobic, are typical examples.

Traditionally, a lithographic plate is photographically imaged. The plate substrate is most commonly aluminum, treated so that the printing surface is hydrophilic, although treated or untreated plastic or paper substrates are also used. The hydrophilic substrate is then coated with one or more layers of materials which function as the imageable layer of the plate. The deposited coatings vary considerably and much effort has been expended by many parties in industry to develop coatings of increased sensitivity and durability

At least one of the layers of the plate coating is sensitive to light of some wavelength or another. Ultra-violet, visible and infrared light-sensitive coating compositions for lithographic printing plates are well known in the art. Many conventional plates are ultraviolet-sensitive in the 325 nm to 430 nm range, being based on diazo-materials, and lithographic printing plates suitable for offset printing are typically produced from these plates via processes similar to a photographic process.

To prepare a lithographic plate for use as a wet offset printing plate, commonly referred to as a printing master, in order to differentiate between the blank plate and the processed plate, the plate is first exposed to light in the pattern to be printed using a photographic film negative. The exposed plate is then washed in a developing solution. In one group of plate products, known as negative-working plates, the exposed areas of the plate coating are insoluble and the development process quantitatively removes the unexposed areas of the coating from the hydrophilic aluminum surface of the plate substrate. By convention such a preparation process is referred to as a negative-working process because the unexposed coating is removed. Diazonium salt-based plates, as a specific group, represent a typical example of conventional ultra-violet sensitive negative-working plates.

Conversely, in a positive working process, the pattern to be printed is masked and the photosensitive exposed coating is rendered soluble in a developer. Until after the development step, the printing artisan or press operator generally endeavors to not allow incidental exposure of the plate to typical white light or sunlight. Undeveloped plates are typically only handled in low light or “yellow light” rooms or conditions.

Traditionally, lithographic plates have been imaged by photographic transfer from original artwork. Unfortunately, this process is labor-intensive and costly. Hence, with the advent of the computer engendering a revolution in the graphics design process preparatory to printing, there have been extensive efforts to directly pattern printing plates, in particular lithographic printing plates, using a computer-controlled apparatus such as a platesetter which is supplied with digital data corresponding to the image to be printed. A typical platesetter has the capability to supply an image-forming agent, typically light energy or one or more chemicals, to a plate according to various images as defined by digital data, i.e., to imagewise apply an image-forming agent. The term “computer-to-plate” has been generally used to describe such machines that are capable of directly imaging printing plates from computer data.

Typical computer-to-plate systems variously use ablative thermal plates, where the image is imparted to the plate by ablating away the areas that are not to be printed (inherently positive-working), and, more recently, thermal plates that are imaged with lower power laser beams that induce by various mechanisms a change in the hydrophilicity or oleophilicity of the imaged area. Typically, but not exclusively, comparatively lower cost near-infra-red diode lasers are employed and light-to-heat converter materials are added to the coating on the plate to adapt the plate to the wavelength of the laser. Both positive and negative-working variants of such media have been developed.

A special type of a computer-to-plate process involves the exposure of an offset lithographic printing precursor while it is mounted on a plate cylinder of a printing press. This is done by means of a plate-setter that is integrated in the press. This method may be called computer-to-press and printing presses with an integrated plate-setter are sometimes called digital presses. A review of digital presses is given in the Proceedings of the Imaging Science & Technology's 1997 International Conference on Digital Printing Technologies (Non-impact Printing 13). Computer-to-press (CTP) methods have been widely described and are well known to those schooled in the art of commercial printing. Typical plate materials used in computer-to-press methods are based on ablation. A problem associated with ablative plates, is the generation of debris, which is difficult to remove and may disturb the printing process or may contaminate the exposure optics of the integrated image-setter.

Other methods require wet processing with chemicals. Such processes may damage or contaminate the electronics and optics of the integrated image-setter and other devices of the press.

Whereas an offset lithographic printing precursor normally consists of a sheet-like support and one or more functional coatings, computer-to-press methods have been described wherein a composition, capable of forming a lithographic surface upon image-wise exposure and optional processing, is provided directly on the surface of a plate cylinder of the press. Techniques have also been described in which a coating of a hydrophobic layer is applied directly on the hydrophilic surface of a plate cylinder. After removal of the non-printing areas by ablation, a master is obtained. However, ablation should be avoided in computer-to-press methods, as discussed above. In U.S. Pat. No. 5,713,287 (Gelbart) a computer-to-press method is described wherein an imageable medium is applied directly on the surface of a plate cylinder. The imageable medium is converted from a first water-sensitive or oil-sensitive property to an opposite water-sensitive or oil-sensitive property by image-wise exposure.

Most of the computer-to-press methods referred to above use so-called thermal or heat-mode materials, i.e. offset lithographic printing precursors or on-press coatable compositions, which comprise a compound that converts absorbed light into heat. The heat which is generated on image-wise exposure triggers a (physico-)chemical process, such as ablation, polymerization, insolubilization by cross-linking of a polymer, decomposition, or, alternatively, particle coagulation of a thermoplastic polymer latex, and after optional processing, a lithographic image is obtained.

A computer-to-press method has also been disclosed in which an oleophilic substance is image-wise transferred from a foil to a rotary press cylinder by melting said substance locally with a laser beam. The strip-shaped transfer foil has a narrow width compared to the cylinder and is translated along a path which is parallel to the axis of the cylinder while being held in close contact with the surface of the cylinder so as to build up a complete image on that surface gradually. As a result, this system is rather slow and requires a long downtime of the printing press, thereby reducing its productivity.

An on-press coating method has been described wherein an aqueous liquid, comprising a hydrophilic binder, a compound capable of converting light to heat and hydrophobic thermoplastic polymer particles, is coated on the plate cylinder so as to form a uniform, continuous layer thereon. Upon image-wise exposure, areas of the coated layer are converted into a hydrophobic phase, thereby defining the printing areas of the printing master. Such methods of on-press coating, on-press exposure and on-press cleaning of the master are commercially attractive, because such presses require less human intervention than conventional presses.

Coating of plate masters off press has existed since the 1960's as hand-wiped plates. This process, due to poor coating quality associated with hand coating, has fallen out of favour given increased demand for quality printing and has in general been replaced by pre-coated plates. In the case of hand-coated plates, however, the substrates were not reused. There is value in reusing the lithographic substrate as the materials and production of such substrate can be costly. This becomes even more feasible for shorter print runs where the mechanical properties of the substrate do not degrade significantly. There is thus interest in the process of reusing lithographic substrates by removing the printing master from the press, and installing it in a separate device whereby the printing surface is removed, the substrate is recoated, and optionally imaged for reuse in printing.

As may be seen from the foregoing, the technology of on-press imaging and on-site platemaking has made major strides and represents a significant benefit to industry. However, there remains a need associated with coating substrate materials, both on-press and in dedicated off-press coating and imaging equipment, in that operators of such facilities wish to have costs reduced as far as possible. This has led to the need for re-usable printing plates. In the case of fully on-press platemaking, the lithographic support may be the cylinder of the press itself. As this is an expensive piece of high precision equipment, the platemaking process employed needs to allow for the repeated re-use of this cylinder.

Various attempts have been made to address this issue by creating cylinders that have permanent oxide or ceramic coatings that may be switched between various states of hydrophilicity by incident imagewise applied radiation. The inherent problem with all of these switchable drum technologies is that inadequate lithographic latitude is obtained in that the variation in hydrophilicity induced in the permanent oxide or ceramic layer is simply inadequate to produce a reliable industrial result outside the laboratory under practical pressroom conditions.

Heretofore many of the new CTP systems have been relatively large, complex, and expensive, being characterized by having sophisticated servo-mechanics and optics in order to both manage the light from laser arrays and provide the required resolution on the plate over large areas. They are often used by larger printing companies as a means to streamline the prepress process of their printing operations, and to take advantage of the rapid exchange and response to the digital information of graphic designs provided by their customers. There remains a strong need for a lower cost economical and efficient CTP system for the many smaller printers who utilize lithographic printing.

In recent years, inkjet printers have replaced laser printers as the most popular hard copy output printers for computers. Inkjet printers have several competitive advantages over laser printers. One advantage is that, as a result of semiconductor processing technological advances, it is possible to manufacture arrays of hundreds of inkjet nozzles spaced very accurately and closely together in a single inexpensive printhead. This nozzle array manufacturing capability enables fast printing ink-jet devices to be manufactured at a much lower cost than laser printers requiring arrays of lasers. The precision with which such a nozzle array can be manufactured, combined with the jetting reliability of the incorporated nozzles, allow these arrays to be used to print high quality images comparable to photo or laser imaging techniques. Inkjet printers are increasingly being used for prepress proofing and other graphic arts applications requiring very high quality hard copy output. In spite of the large and rapidly growing installed base of inkjet printers for hard copy output, inkjet printing technology is not commonly used in CTP systems.

There are many challenging technical requirements facing the practitioner who would design such an inkjet based CTP system as can be seen in the prior art. A first requirement is that the inkjet ink used to image the printing plate be jettable, able to form ink drops of repeatable volume and in an unvarying direction. Further, for practical commercial application, the ink must have a long shelf life, in excess of one year or more.

While there is a considerable body of art on the subject of platemaking via ink-jet, those that address the making of non-relief lithographic (that is, non-gravure and non-flexographic) plates very often focus on depositing the material that is to form oleophilic ink-bearing areas. Some processes are also specifically directed to the making of waterless plates in this way. In a more limited number of cases there is some form of chemical reaction, either between different inkjetted materials, or between inkjetted materials and materials pre-coated on the plate, to create, via this reaction, a third material composition which is either removed by development (positive working) or which creates the areas to be inked (negative-working). Some inventions employ special additives to the ink or special chemical on the plate surface to trigger, enhance or stimulate this process in some way or another.

U.S. Pat. No. 6,315,916 (Deutsch, et al.) describes an example of a reactive process for preparing wet offset lithographic plates by inkjet imaging of presensitized plates comprising “diazo” compounds. According to this process, an alkaline or chemically basic ink comprising one or more suitable pH elevating chemicals is imagewise jetted onto a lithographic plate having a coating comprising “diazo” compounds. The latent image on the plate is cured by heating, and next developed by washing with a conventional chemical development solution.

To the extent that the present specification addresses the use of imageable media comprising polymer particles, a short description of some known media of that general type is provided herewith. Various forms of imageable medium of this generic type have been described. Central to their working is the concept of coalescence of the hydrophobic polymer particles under thermal action to form hydrophobic ink-bearing areas for use in lithographic printing. In some cases, the particles are described as being oleophilic rather than hydrophobic. It is specifically to be noted that the imageable media of this generic type do not function on the basis of an imaging-induced change in solubility, the hydrophobic polymer particles of which they are comprised remaining fundamentally insoluble in the developers employed both before and after imaging.

U.S. Pat. No. 3,476,937 (Vrancken), U.S. Pat. No. 3,793,025 (Vrancken et al.), U.S. Pat. No. 3,679,410 (Vrancken et al.) and U.S. Pat. No. 4,004,924 (Vrancken et al.) describe how hydrophobic thermoplastic polymer particles may be employed in an offset lithographic printing precursor for use in imaging variously by visible light and thermal means. Numerous patents have been based on this early work, which has also led to commercial products based on this broad principle. One example is the Thermolite (trademark) product from Mortsel, Belgium. U.S. Pat. No. 6,001,536 (Vermeersch et al.) describes using a derived format of this kind of media as comprising, on a hydrophilic surface of a lithographic base, hydrophobic thermoplastic polymer particles dispersed in a hydrophilic binder and a compound capable of converting light to heat. A number of further patents, and applications for patents, by the same inventor describe the same generic media. This kind of media is developed by plain water or an aqueous medium after illumination with radiation of wavelength matching the sensitivity of the compound capable of converting light into heat.

U.S. Pat. No. 4,731,317 (Fromson et al.) discloses that non-film forming polymer emulsions such as LYTRON 614, which is a styrene-based polymer with a particle size on the order of 1000 Angstroms, can be used, alone or with an energy absorbing material such as carbon black, to form an image according to the invention of that patent. A polymer emulsion coating, coated onto a substrate, is not light sensitive but the substrate used converts laser radiation to a level of radiation that will fuse the polymer particles in the image area. In other words, the glass transition temperature (Tg) of the polymer is exceeded in the imaged areas thereby fusing the image in place onto the substrate. The background can be removed using a suitable developer to remove the non-laser struck portions of the non-film form coating. Since the fused polymer is ink loving, this results in a negative-working lithographic master.

U.S. Pat. No. 5,609,980 and U.S. Pat. No. 5,928,833 (Matthews et al.) describe an imageable medium, based on core-shell particles, comprising an oleophilic water-insoluble, heat softenable core-component having a minimum film-forming temperature above room temperature, and a shell component that is swellable or soluble in aqueous medium. The core and shell component of the particles coalesce upon heating.

U.S. Pat. No. 4,273,851 (Muzyczko et al.) describes a latex system that includes particulates of water-insoluble polymers in combination with other water soluble or water-dispersible materials. Upon coating onto a substrate, this provides a two-phase system of emulsion particulates in light sensitive polymer. When selected areas are subjected to actinic radiation, a water insoluble matrix is formed. The portions of the system that were not subjected to actinic radiation are then readily washed from the coated item to form hydrophilic, non-image areas. This describes a basic negative-working lithographic master.

### BRIEF SUMMARY OF THE INVENTION

The invention provides a method for making a negative-working lithographic master using an offset lithographic printing precursor comprising an imageable medium on a hydrophilic base, wherein the imageable medium comprises hydrophobic polymer particles. The method comprises imagewise inkjet deposition of droplets of a coalescing agent on the imageable medium on the offset lithographic printing precursor, thereby causing the hydrophobic polymer particles to coalesce imagewise, forming areas of hydrophobic material. The areas of the imageable medium that are not coalesced may then be removed by a developer, which is typically, but not necessarily, aqueous. The coalesced areas remain substantially resistant to the developer. As a result, those areas that are written with the coalescing agent will be hydrophobic after development and be capable of carrying printing ink. The same areas will therefore render an image during wet lithographic offset printing. The combination of imageable medium, comprising hydrophobic polymer particles, and a coalescing agent may be used in the fully on-press fabrication of a negative-working lithographic master, which may optionally may also be made on a re-usable base.

### DETAILED DESCRIPTION OF TH PREFERRED EMBODIMENT

The method of the present invention comprises imagewise inkjet deposition of droplets of a coalescing agent on an offset lithographic printing precursor. The offset lithographic printing precursor comprises an imageable medium on a hydrophilic lithographic base, the imageable medium comprising hydrophobic polymer particles. The action of the coalescing agent is to cause the hydrophobic polymer particles to become imagewise coalesced, forming areas of hydrophobic material representing the image to be printed. The areas of the imageable medium that are not coalesced may then be removed by a developer, which is typically, but not necessarily, aqueous. This development process exposes the underlying hydrophilic lithographic base in this process. The imagewise coalesced areas are substantially resistant to the developer and are not removed by the developer. By this method, an inherently negative-working lithographic master is produced.

### Definitions

In this specification the following terms are taken to mean:

Offset “lithographic printing precursor” is used to describe any printing plate, printing cylinder or printing cylinder sleeve, or any other surface bearing a coating of imageable material that may be either converted or removed imagewise to create a surface that may be inked selectively and used for offset lithographic printing.

“Imaged printing plate precursor” is used to describe any printing plate, printing cylinder or printing cylinder sleeve, or any other surface bearing a coating of imageable material that has been converted to produce imagewise areas with differing solubility to unconverted areas to the action of developer.

“Lithographic printing master,” or exchangeably the term “master,” is used in this specification to describe the selectively inkable surface so created.

“Lithographic base” is used herein to describe the base onto which the imageable material is coated. The lithographic base may be, but is not limited to, a printing plate, printing cylinder or printing cylinder sleeve. The lithographic base may further comprise a number of surface layers or coatings, the topmost one of which may be a hydrophilic layer. The hydrophilic layer may be a cross-linked hydrophilic polymer.

“Imageable medium” is used herein to describe a medium which, when coated as a layer on a lithographic base, may be imaged by any means.

“Imageable coating” is used to describe the coating so created. The imageable coating may be positive-working or negative-working. In a negative-working form, it is removable by a developer to reveal the underlying lithographic base, and, where imaged, will become hydrophobic in the imaged areas and be resistant to the developer in those areas. In a positive-working form, it is removable by a developer in the areas where it is imaged, but remains substantially resistant to the same developer in areas that are not imaged.

“Negative-working lithographic printing master” is used to describe a lithographic printing master on which, during the process of transferring printing ink from the master to a printing medium for receiving printing ink, the printing ink adheres to those areas that were irradiated or written to in any way whatsoever by an imaging head and, conversely, on which printing ink does not adhere to those areas that were not irradiated or written to in any way by that imaging head. Whether the master is referred to as negative-working or positive-working is therefore not determined by the means of creating ink-bearing and non-ink-bearing areas on the master, but rather by whether the positive image to be created on the printing medium for receiving the printing ink, or the negative of it, is transferred to the master from the imaging head. In brief, on a “negative-working lithographic printing master”, those areas that are written by the imaging head will carry printing ink.

“Uncoalesced” is used herein to describe a state of an assemblage of polymer particles that are not substantially fused together, thermally or chemically. This is to be contrasted with coalesced polymer particles where a plurality of particles has essentially fused together to form a contiguous whole.

“Imagewise converted” is used herein to describe the conversion of the imageable medium under the action of a coalescing agent that is imagewise deposited on the imageable medium.

“Curing” or “cured” is here to be understood to include the hardening of the imagable medium, specifically including the drying thereof, either with or without cross-linking of the incorporated polymer.

### Apparatus

In accordance with a preferred embodiment of the invention, a computer-to-plate system comprising an inkjet printer and a conventional developing processor machine is used. In the most preferred embodiment, the inkjet printer used is a commercially available drop-on-demand printer capable of printing small ink drops, such as for example the EPSON Stylus Color 3000 inkjet printer available from Epson America, Inc., Long Beach, Calif. In an alternative embodiment a continuous inkjet printer head can be used, such as those supplied by Iris Graphics of Billerica, Mass. However, the great flexibility available to the practitioner in formulating a coalescing agent according to the invention means that a well-performing jettable coalescing agent can be formulated such that the printhead of almost any inkjet printer will be able to form regular drops with good reliability.

To facilitate accurate imaging of the plate, the paper-handling or substrate-handling subsystem of inkjet printer should have a short, straight paper path. A printing plate is generally stiffer and heavier than the paper or media typically used in commercially available inkjet printers. If the plate fed into the printer mechanism must bend before or after being presented to the imaging printhead, then the movement of the plate through the printer may not be as accurate as the media for which the printer was designed. The most preferred EPSON Stylus Color 3000 has such a short, straight paper path. A platen is preferably placed at the entrance to the paper feed mechanism. The platen supports the plate as it is pulled into the printer by the mechanism, facilitating the accurate transport of the plate under the imaging printhead.

The combination comprising the coalescing agent and imageable medium may optionally be used in an apparatus that combines the making of the offset lithographic printing precursor and the imagewise deposition of the coalescing agent. As described in U.S. Pat. No. 5,713,287 (Gelbart), a cylindrical hydrophilic lithographic base may be coated with imageable medium and the layer so coated may be cured to create the offset lithographic printing precursor. The inkjet deposition of the coalescing agent may then be performed. The hydrophilic lithographic base may be a plate or a sleeve that fits on or over a cylinder or drum. The plate and sleeve may be re-usable. Instead of using a separate plate or sleeve as hydrophilic lithographic base, a suitably hydrophilic drum or cylinder may be employed. The entire plate-making arrangement may be incorporated on a press to create a fully on-press plate-making facility. The hydrophilic lithographic base may also be re-usable upon removal of any existing imaged areas of positive-working offset radiation-imageable medium, this being particularly useful in the case where the drum or cylinder itself provides the hydrophilic lithographic base.

### Process

In a preferred embodiment, the imagable coating may be applied to the lithographic base while the latter resides on the press. The lithographic base may be an integral part of the press or it may be removably mounted on the press. In this embodiment the imagable coating may be cured by means of a curing unit integral with the press, as described in U.S. Pat. No. 5,713,287 (Gelbart).

Alternatively, the imagable coating may be applied to the lithographic base and cured before the complete offset lithographic printing precursor is loaded on the printing cylinder of a printing press. This situation would pertain in those cases where the offset lithographic printing precursor is prepared separate from the press.

Before applying the imagable coating to the lithographic base, the lithographic base may be treated to enhance the developability or adhesion of the imageable coating. The coating of the layer of imageable medium is effected in a known manner by, for example, spraying, dipping, roller application, by means of slot dies, blade-application or other coater application.

In the preferred embodiment of the invention, the imageable material of the imageable coating is imagewise converted by means of the inkjet deposition of a coalescing agent. This process may be conducted off-press, as on a plate-setting machine, or on-press, as in digital-on-press technology.

When the coalescing agent is imagewise deposited on the imageable coating of the offset lithographic printing precursor, the hydrophobic polymer particles in the imageable medium are imagewise coalesced in the addressed areas. In the areas of the imageable coating affected by the coalescing agent, the imageable medium is rendered hydrophobic through the coalescence of the hydrophobic polymer particles of which the imageable medium is comprised, the hydrophobic coalesced areas so formed being substantially resistant to developer. They also adhere well to the hydrophilic surface of the lithographic base. After application of the coalescing agent, the plate may be optionally heated. Such optional heating may be to temperatures below the glass transition temperature of the material of the hydrophobic polymer particles for the purposes of completing the chemical coalescing process.

After the application of the coalescing agent and optional heating, the offset lithographic printing precursor is developed. This is done either by hand, or preferably with a conventional developing processor using a developer solution. In the specific case of the preferred embodiment described here thus far, the developer solution may be plain tap water, with an optional surfactant, and may alternatively be commercial fountain solution as used on commercial presses.

During such development, the area of coalesced hydrophobic polymer particles will not allow water or aqueous medium to penetrate it or adhere to it, while the unexposed areas of the imageable coating may be readily washed off using a developer, thereby exposing the hydrophilic surface of the lithographic base. In a preferred embodiment, the developer solution may be an aqueous medium, such as fountain solution. Again, as described in U.S. Pat. No. 5,713,287 (Gelbart), this process may be conducted on the press as part of the digital-on-press technological approach, but may also alternatively be conducted in a commercial developing machine or a developer bath.

The lithographic printing master created by the above steps may then optionally be treated with gum in accordance with processes well known to those skilled in the art of offset plate making to produce a negative-working lithographic printing master ready for printing. If desired, because of the printing application, the developed plate may be post-baked, or treated with gum and post-baked to achieve an additional toughening of the coalesced areas of the imageable coating. These treatments are well known to practitioners of the art. An example treatment is described in patent GB1513368.

The lithographic printing master may subsequently be inked with an oil-based lithographic ink. In this process, the exposed areas of the imagable coating will be the areas to which the lithographic printing ink will adhere. This makes possible the subsequent use of the inked surface for the purposes of printing.

At the end of a printing run, the lithographic base may be cleaned by removing the remaining imageable coating. In the alternative case of a lithographic base comprising a cross-linked hydrophilic polymer layer, that layer also may be removed and subsequently re-coated. The entire process described above may then be repeated for a new image to form a new lithographic printing master. This cleaning process may be performed on-press, as described in U.S. Pat. No. 5,713,287 (Gelbart), or off-press in a separate cleaning unit.

### Coalescing Agents

The coalescing agent comprises a coalescent, and optionally a co-solvent. In the present specification the term coalescent is used to describe a material that causes coalescence of dispersed polymer particles. The following non-limiting examples are provided of materials functioning as coalescents.

Ethylene glycol-derived ethers (E-series ethers) and esters such as ethyleneglycol monobutyl ether, ethyleneglycol monomethyl ether, ethyleneglycol monomethyl ether acetate and ethyleneglycol monoethylether acetate; glycol ethers and esters derived from propylene glycol (P-series ethers), including propylene glycol tert-butyl ether (PTB), propyleneglycol monoethyl ether, propyleneglycol monophenyl ether and propyleneglycol monomethyl ether acetate and propyleneglycol monoethyle ether acetate.

Diethyleneglycol ethers and esters may be derived from an alkyl diglycol ether and a carboxylic acid. The carboxylic acid used to produce the ester may be selected from one or more of an aliphatic, alicyclic and an aromatic mono- or dicarboxylic acid and functionally substituted derivatives thereof. Specific examples of such esters include Diethylene glycol-monomethylether, diethylene glycol-monoethylether, diethylene glycol-mono n-propylether, diethylene glycol-mono-iso-propyl ether, diethylene glycol-mono n-butylether, diethylene glycol-mono-iso-butyl ether and diethylene glycol-mono-tertiary butylether; equivalent dipropylene glycol and dibutyleneglycol materials also can be used examples include:—Dipropylene glycol-monomethyl ether, dipropylene glycol-monoethylether, dipropylene glycol-mono n-propylether, dipropylene glycol-mono-iso-propyl ether, dipropylene glycol-mono n-butyl ether, dipropylene glycol-mono-iso-butyl ether and dipropylene glycol-mono-tertiary butyl ether; Dibutylene glycol-monomethyl ether, dibutylene glycol-monoethylether, dibutylene glycol-mono n-propylether, dibutylene glycol-mono-iso-propyl ether, dibutylene glycol-mono n-butyl ether, dibutylene glycol-mono-iso-butyl ether and dibutylene glycol-mono-tertiary butyl ether; and Butoxyethoxy propanol. Both the monoesters, such as the propionates, n-butyrates and iso-butyrates, and the diesters such as the oxalates, malonates and succinates of glycols can also be used to coalesce the imageable coating, for example, 2,2,4-trimethylpentane-1,3-diol monisobutyrate, 2-alkyl-1,3-hexanediol alkyl esters, 2-ethyl-1,3-hexanediol monoutyrate, 2-ethyl-1,3-hexanediol isobutyrate, 2-methyl-1,3-hexanediol monobutyrate and 2-methyl-1,3-hexanediol isobutyrate, diesters of aliphatic C₂-C₆ dicarboxylic acids, dimethyl succinate, diethyl succinate, and diisopropyl succinate.

Other suitable ether-esters include 2-ethoxyethyl p-toluate, 2-ethoxyethyl benzoate, 2-(2-ethoxyethoxy)ethyl p-toluate, 2-(2-ethoxyethoxy)ethyl benzoate, 2-propoxyethyl o-toluate, 2-propoxyethyl benzoate, 2-ethoxyethyl o-toluate, etc. In fact, among preferred coalescents are a mixture of 2-ethoxyethyl p-toluate and 2-ethoxyethyl benzoate and a mixture of 2-(2-ethoxyethoxy)ethyl p-toluate and 2-(2-ethoxyethoxy)ethyl benzoate.

Glycols, for example hexylene glycol, can also be used.

The above are all classical coalescent agents in which the evaporation rate of the agent is slow, generally slower than water. Many others of this type are known and described in the patent literature in the general area of paint.

In addition to these materials other solvent-like coalescing agents can be used that have evaporation rates significantly higher than, or approximately equal to that of water. Examples include aliphatic ketones such as methyl isobutylketone, cyclohexanone; esters such as ethyl propionate or isobutyl acetate; ethers such as dioxane; alcohols such as isobutanol and hydrocarbons such as cyclohexane or toluene.

Mixtures of the materials exemplified above or other similar materials are also satisfactory for providing the coalescence of the latex or dispersion. The coalescent is chosen according to the nature of the polymer. Persons skilled in the art are able to make appropriate combination of polymer latex and coalescent.

### Optional Additions to Coalescing Agent

The coalescing agent employed in the present invention may comprise various additions to the coalescent in order to improve its functioning:

A co-solvent may be added to increase jetting reliability, so that the coalescing agent does not dry out in the inkjet nozzle during idle periods causing it to clog. A humidifying co-solvent, including water, may be added to the masking ink. The co-solvent can be polyhydric alcohols such as glycerin, ethoxylated glycerin, ethylene glycol, diethylene glycol, triethylene glycol, propylene glycol, dipropylene glycol, or trimethylol propane, other high boiling point liquids such as pyrrolidone, methylpyrrolidone, or triethanol amine, other simple alcohols such as isopropyl alcohol or tertiary butyl alcohol, or mixtures of such solvents. The co-solvent may typically comprise up to 97 percent of the coalescing agent composition.

An indicator dye, compatible with the coalescent and co-solvent, may also be added at a level of a few percent to enhance the visibility of the latent image. This is useful in facilitating the inspection of the imaged plate, before it is subjected to the developer.

The coalescing agent may also optionally contain one or more surfactants or wetting agents to control the surface tension of the coalescing agent, enhancing jettability, and to control the spread of the drop on the imageable coating. The surfactants and wetting agents may include Iconol DA, Iconol NP, Iconol OP, Iconol TDA, Surfonyl TDA, Surfonyl TG-E, Strodex, Cal-Fax, Tergitol TMN, Tergitol X, Tergitol 15-S, IPA, Iso-butanol, and similar chemicals or mixtures of similar chemicals. When used, surfactants and wetting agents typically comprise 0.001 to 10 percent of the coalescing agent.

The coalescing agent may additionally contain biocides to prolong the shelf life of the ink. Suitable biocides include for Kathon PFM, CanGuard 409, Sumquat 6020, and similar chemicals or mixtures of such chemicals. When used, the biocide would typically comprise 0.1 to 3 percent of the coalescing agent. Further materials may be added to the coalescent agent in order to provide it with electrical conductivity, such as may be required for continuous inkjet systems.

A preferred formulation for a coalescing agent may comprise:

Water 25%; co-solvent 25%; coalescent 45%; dye 2%; surfactant 2%; Biocide 1%.

### The Imageable Medium

The preferred imageable medium of the present invention is comprises hydrophobic polymer particles. Various prior art media of this generic type have been described in the background section above. A preferred medium of this type is described in more detail below. Central to the working of the various specific forms of this kind of media, is the concept of coalescence of the hydrophobic polymer particles under thermal action to form hydrophobic ink-bearing areas for use in lithographic printing. In some cases, the particles are described as being oleophilic rather than hydrophobic. Commercially offset lithographic printing precursors are prepared that are based on coating a hydrophilic lithographic base with an emulsion or latex or suspension of such hydrophobic polymer particles in various binders or in water or other carriers. Often this suspension, latex or emulsion has added to it a light-to-heat convertor substance that converts incident imaging radiation into heat. The addition of this component allows the medium to be adapted to a particular wavelength of laser light and thereby facilitates overall performance. For the present invention, such converter substances are not required, but may be allowed to be present. Various further additives may also be included in the medium to obtain further ancillary functional performance.

The preferred imageable medium of the present invention comprises hydrophobic polymer particles and a coalescence inhibitor. Various generic and specific coalescence inhibitors may be used. We describe here this generic imageable medium, which may or may not comprise a substance capable of converting light to heat.

(a) Hydrophobic Polymer Particles

Specific examples of hydrophobic polymer particles for use in connection with the present invention preferably have a glass transition temperature above 40 degrees C. Preferred hydrophobic polymer particles are polyvinyl chloride, polyethylene, polyvinylidene chloride, polyacrylonitrile, poly(meth)acrylates etc., copolymers or mixtures thereof. More preferably used are polymethyl-methacrylate or copolymers thereof. Polystyrene itself or polymers of substituted styrene are particularly preferred, most particularly polystyrene copolymers or polyacrylates. The weight average molecular weight of the hydrophobic polymer in the dispersion may range from 5,000 to 1,000,000 g/mol.

The hydrophobic polymer in the dispersion may have a particle size from 0.01 μm to 30 μm, most preferably between 0.01 μm and 0.3 μm. The hydrophobic polymer particle is present in the liquid of the imagable coating.

A suitable method for preparing an aqueous dispersion of the polymer comprises the following steps:

(a) dissolving the hydrophobic polymer in an organic water immiscible solvent with a boiling point less than 100 C,

(b) dispersing the solution in water or an aqueous medium and

(c) evaporating the organic solvent to remove it.

Alternatively it can be prepared by the methods disclosed in U.S. Pat. No. 3,476,937 (Vrancken).

The amount of hydrophobic polymer dispersion contained in the image forming layer is preferably between 20% by weight and 95% by weight and more preferably between 40% by weight and 90% by weight and most preferably between 50% by weight and 85% by weight.

(b) Coalescence Inhibitor

While the present invention works well for media comprising hydrophobic polymer particles in general, the preferred imageable medium of the present invention also comprises a coalescence inhibitor in addition to the polymer particles. The coalescence inhibitors are chosen for their miscibility with or solubility in water, aqueous solution or press fountain solution. The concentration of coalescence inhibitor used is sufficient to make the unexposed dispersion more permeable to water or fountain solution whilst at the same time can be extracted by the fountain solution from the coalesced areas. In operation, the non-coalesced areas (unexposed during the imaging process) are easily developed because of the presence of the coalescence inhibitor. However, during the continuation of the print run the coalescence inhibitor is slowly extracted out of the coalesced areas of the imageable coating due to its solubility in fountain solution. The result is that the coalesced area becomes more hydrophobic. The leaching out of the coalescence inhibitor enhances the long-term durability of the plate throughout its run.

The function of the coalescence inhibitor is such that it should be substantially soluble in the dispersion that is to be coated. In addition to the solubility characteristics, the coalescence inhibitors should also be capable of facilitating the removal of the unexposed portions of the image coat by fountain solution thus enhancing the developability of the uncoalesced portion of the imaging element. Further, the coalescence inhibitor must be capable of being extracted from the coalesced image, thus maintaining the durability of the image area during the print run and increasing the resistance of the image to wear by offset powder or other press-room chemicals.

A further enhancing feature of the incorporation of the coalescence inhibitor is that it permits polymers to be used that have high potential coalescibility. This has the beneficial effect of increasing the scope of choice of polymer. In the present invention, the addition of the coalescence inhibitor allows the mutually independent optimization of the durability, and therefore run length, on the one hand, and the sensitivity of the media in terms of response to the coalescing agent, on the other.

The preferred concentration of such coalescence inhibitors is between 0.1% ww of the hydrophobic polymer particles and 500% ww of the hydrophobic thermoplastic polymer particles. The more preferred concentration of coalescence inhibitor is dependent on the particular class of inhibitor chosen, as exemplified below. However, the concentration of specific coalescence inhibitors should not be so high as to cause attack and dissolution of the anodic layer. Examples of suitable coalescence inhibitors include, but are not limited to:

1. inorganic salts such as sodium acetate, potassium carbonate, lithium acetate, sodium metasilicate etc,

2. organic bases such as piperazine, 2-methylpiperazine and 4-dimethylaminobenzaldehyde,

3. organic acids such as malonic acid, D,L lactic acid and citric acid, and

4. metal complexes such as zinc acetate, copper (II) phthalocyaninetetrasulphonic acid, tetra sodium salt, aluminium acetylacetonate, copper acetylacetonate, cobalt acetylacetonate and zinc acetylacetonate

Preferred concentrations (in % w/w of hydrophobic polymer particles) of the above four categories of coalescence inhibitors are respectively:

| | |
|---|---|
| Inorganic salts: | 2% w/w to 50% w/w, |
| | most preferably 10% w/w to 40% w/w |
| Organic bases: | 50% w/w to 500% w/w, |
| | most preferably 80% w/w to 200% w/w |
| Organic acids: | 0.1% w/w to 100% w/w, |
| | more preferably 10% w/w to 80% w/w and |
| | most preferably 20% w/w to 50% w/w. |
| Metal complexes: | 0.1% w/w to 100% w/w, |
| | more preferably 10% w/w to 80% w/w and |
| | most preferably 20% w/w to 50% w/w |

The coalescence inhibitor could in fact be a mixture of two or more coalescence inhibitors and such a mixture could perform synergistically in a more improved way than any one coalescence inhibitor would suggest. Similarly, coalescence inhibitors that form part of a mixture may not necessarily perform in the desired way when used alone.

In alternative embodiments of the present invention, coalescence inhibitors may be used that modify the surface properties of the polymer particles, thereby inhibiting the chemical coalescence process. This provides an alternative means of control over the chemical coalescence process.

(c) Light-to-Heat Converter Substance

A substance capable of converting light-to-heat may be optionally added to the imageable medium of the present invention. This consideration is important, in that this allows the kind of medium to be employed for non-inkjet-based plate making operations employing photochemical or thermal processes. Thereby a better economy of scale is created for the imageable media. It is important to note that the invention is independent of whether a light-to-heat converter is present or not in the imageable medium. Thus, the same imageable medium may be employed for either inkjet-based platesetting or more conventional photonic or thermal platesetting. Many suitable light-to-heat converter substances are known to practitioners of the art and will not be discussed here.

### Lithographic Bases

The lithographic base used in accordance with the present invention is preferably formed of aluminum, zinc, steel, or copper. The choices of material for the lithographic base include the known bi-metal and tri-metal plates such as aluminum plates having a copper or chromium layer; copper plates having a chromium layer and steel plates having copper or chromium layers. Other preferred lithographic bases include metallized plastic sheets such as poly(ethylene terephthalate).

Particularly preferred lithographic bases are grained, or grained and anodized, aluminum plates where the surface is roughened (grained) mechanically or chemically (e.g. electrochemically) or by a combination of roughening treatments. The anodizing treatment can be performed in an aqueous acid electrolytic solution such as sulphuric acid or a combination of acids such as sulphuric and phosphoric acid.

The anodized aluminum surface of the lithographic base may be treated to improve the hydrophilic properties of its surface. For example, a phosphate solution that may also contain an inorganic fluoride is applied to the surface of the anodized layer. The aluminum oxide layer may be also treated with sodium silicate solution at an elevated temperature, e.g. 90° C. Alternatively, the aluminum oxide surface may be rinsed with a citric acid or citrate solution at room temperature or at slightly elevated temperatures of about 30 to 50° C. A further treatment can be made by rinsing the aluminum oxide surface with a bicarbonate solution.

Another useful treatment to the aluminum oxide surface is with polyvinylphosphonic acid, polyvinylmethylphosphonic acid, phosphoric acid esters of polyvinyl alcohol, polyvinylsulphonic acid, polyvinylbenzenesulphonic acid, sulphuric acid esters of polyvinyl alcohol, and acetals of polyvinyl alcohols formed by reaction with a sulphonated aliphatic aldehyde. It is evident that these post treatments may be carried out singly or as a combination of several treatments.

According to another embodiment in connection with the present invention, the lithographic base has a hydrophilic surface and comprises a flexible support, such as e.g. paper or plastic film, provided with a cross-linked hydrophilic layer. A suitable cross-linked hydrophilic layer may be obtained from a hydrophilic (co)polymer cured with a cross-linking agent such as a hydrolysed tetra-alkylorthosilicate, formaldehyde, glyoxal or polyisocyanate. Particularly preferred is the hydrolysed tetra-alkylorthosilicate.

The hydrophilic (co-) polymers that may be used comprise for example, homopolymers and copolymers of vinyl alcohol, hydroxyethyl acrylate, hydroxyethyl methacrylate, acrylic acid, methacrylic acid, acrylamide, methylol acrylamide or methylol methacrylamide. The hydrophilicity of the (co)polymer or (co)polymer mixture used is preferably higher than that of polyvinyl acetate hydrolyzed to at least an extent of 60 percent by weight, preferably 80 percent by weight.

The amount of crosslinking agent, in particular of tetraalkyl orthosilicate, is preferably at least 0.2 parts by weight per part by weight of hydrophilic (co-) polymer, more preferably between 1.0 parts by weight and 3 parts by weight.

A cross-linked hydrophilic layer of the lithographic base preferably also contains materials that increase the porosity and/or the mechanical strength of this layer. Colloidal silica employed for this purpose may be in the form of any commercially available water-dispersion of colloidal silica having an average particle size up to 40 nm. Additionally inert particles of a size larger than colloidal silica may be used e.g. alumina or titanium dioxide particles or particles having an average diameter of at least 100 nm but less than 1 μm which are particles of other heavy metal oxides. The incorporation of these particles causes a roughness, which acts as storage places for water in background areas.

The thickness of a cross-linked hydrophilic layer of a lithographic base in accordance with this embodiment can vary between 0.5 to 20 μm and is preferably 1 to 10 μm. Particular examples of suitable cross-linked hydrophilic layers for use in accordance with the present invention are disclosed in EP 601240 (Vermeersch et al.), GB-P-1419512, FR-P-2300354, U.S. Pat. No. 3,971,660 (Staehle), and U.S. Pat. No. 4,284,705 (Phlipot et al.).

A particularly preferred substrate to use is a polyester film on which an adhesion-promoting layer has been added. Suitable adhesion promoting layers for use in accordance with the present invention comprise a hydrophilic (co-) polymer and colloidal silica as disclosed in EP 619524 (Hauquier et al.), and EP 619525 (Hauquier et al.). Preferably, the amount of silica in the adhesion-promoting layer is between 0.2 and 0.7 mg per m². Further, the ratio of silica to hydrophilic binder is preferably more than 1 and the surface area of the colloidal silica is preferably at least 300 m² per gram.

### Alternative Imageable Media

In further embodiments of the present invention, the imageable medium employed may be one of those described in patents U.S. Pat. No. 3,476,937 (Vrancken), U.S. Pat. No. 3,679,410 (Vrancken et al.), U.S. Pat. No. 3,793,025 (Vrancken et al.), U.S. Pat. No. 4,004,924 (Vrancken et al.), U.S. Pat. No. 4,273,851 (Muzyczko et al.), U.S. Pat. No. 5,609,980 (Matthews et al.), U.S. Pat. No. 5,928,833 (Matthews et al.) and U.S. Pat. No. 6,001,536 (Vermeersch et al.) as well as the styrene-based polymer emulsion disclosed in U.S. Pat. No. 4,731,317 (Fromson et al.). These have all been described in the background of the present application for letters patent. The coalescing agent and developer solution may be suitably adapted to match the chemistry of each of the individual media, the common factors remaining the chemical coalescence of the polymer particles rather than their thermal coalescence and the subsequent removal of the uncoalesced imageable medium by means of the developer solution selected for that imageable medium.

The following example serves to illustrate an embodiment of the invention.

### EXAMPLE

Six grams UCAR 471 polymer (Union Carbide, Danbury, Conn.), 12 grams 5 wt. % sodium carbonate in deionized water, 12 grams 1 wt. % ADS 830A infra-red absorbing dye (American Dye Source Inc., Montreal, Canada) in ethanol and 36 grams deionized water are mixed and the resultant emulsion is coated onto a grained, anodized aluminum plate. (The ADS 830A dye is not required for the purposes of the present invention, but is included in the emulsion so that the emulsion can be used in other applications, for example, ones in which imaging is performed by means of a laser. The presence of the dye does not affect its functionality for purposes of the present invention). The coating is dried in an oven at 60° C. for one minute. When the coating is dry, a coating weight of 0.9 grams per square meter is obtained. The plate is mounted onto a single color SM74 press (Heidelberg Druckmaschine, Germany) and imaged by applying imagewise a coalescing agent by means of the inkjet printhead of an Epson Stylus Color 300 inkjet printer. The coalescing agent comprises (by weight) 55% water, 25% glycerin, 15% ethyleneglycol monobutyl ether, 2% dye, 2% Iconol DA and 1% Kathon PFM. Following imaging, the coalesceing agent is allowed to complete its action and the plate is inspected and then washed with fountain solution for twenty seconds. Ink is applied to the printing plate so-formed. The resulting inked printing plate is used to make repeated printed copies.

There have thus been outlined the important features of the invention in order that it may be better understood, and in order that the present contribution to the art may be better appreciated. Those skilled in the art will appreciate that the conception on which this disclosure is based may readily be utilized as a basis for the design of other methods and apparatus for carrying out the several purposes of the invention. It is most important, therefore, that this disclosure be regarded as including such equivalent methods and apparatus as do not depart from the spirit and scope of the invention.

What is claimed is:

1. A method for making a lithographic printing master, the method comprising the steps of:
a. providing a printing precursor comprising on a lithographic base an imageable coating, the imageable coating comprising hydrophobic polymer particles,
b. imagewise converting the imageable coating with a liquid coalescing agent and
c. removing the areas of the imageable coating that have not been imagewise converted using a developer.

2. The method of claim 1, wherein the imageable coating further comprises a coalescence inhibitor.

3. The method of claim 1, wherein the step of providing comprises the steps of
a. coating of a layer of imageable medium onto the lithographic base and
b. curing the layer to form the imageable coating.

4. The method of claim 1, comprising the further step of heating the imagewise converted imageable coating.

5. The method of claim 1, wherein the method is performed on a lithographic press.

6. The method of claim 3, wherein the method is performed on a lithographic press.

7. A method according to claim 1, wherein the liquid coalescing agent comprises at least one of a hydrocarbon, an ether, an ester, a glycol, a carbonyl and an alcohol.

8. A method according to claim 7, wherein the coalescing agent additionally comprises at least one of
a. an indicator dye,
b. a surfactant,
c. a biocide and
d. a substance capable of modifying the electrical conductivity of the coalescing agent.

9. The method of claim 1, wherein the developer is an aqueous developer.

10. The method of claim 9, wherein the aqueous developer is one of
a. fountain solution and
b. a liquid comprising tap water.

11. The method of claim 5, wherein the developer is fountain solution.

12. A printing apparatus comprising
a. an inking means for inking a lithographic printing master,
b. a means for applying fountain solution to at least one of
i. a lithographic precursor and
ii. a lithographic printing master,
c. a deposition means capable of imagewise depositing coalescing agent on a lithographic precursor.

13. The apparatus of claim 12, further comprising,
a. a coating means capable of coating imageable medium onto a lithographic base and
b. a curing means capable of curing imageable medium that has been coated onto a lithographic base.

14. An apparatus for making a lithographic printing master, the apparatus comprising
a. a coating means capable of coating an imageable medium onto a lithographic base,
b. a curing means capable of curing the imageable medium that has been coated onto the lithographic base, thereby to form a lithographic precursor, and
c. a deposition means capable of imagewise depositing coalescing agent on a lithographic precursor to form an imaged precursor.

15. The apparatus of claim 14, further comprising a means capable of treating the imaged precursor with a developer.

16. The apparatus of claim 15, wherein the developer is one of
a. fountain solution and
b. a liquid comprising tap water.
